(19) United States
(12) Patent Application Publication
(10) Pub. No.: US 2016/0258205 A1
(43) Pub. Date: Sep. 8, 2016

(54) OFFSET SEAM FOR INSULATING GLASS UNIT SPACER AND METHOD OF USING AND MANUFACTURING THE SAME

(71) Applicant: Andersen Corporation, Bayport, MN (US)

(72) Inventor: Sammy H. Oquendo, Haskell, NJ (US)

(21) Appl. No.: 15/058,862

(22) Filed: Mar. 2, 2016

Related U.S. Application Data
(60) Provisional application No. 62/127,603, filed on Mar. 3, 2015.

(51) Int. Cl. E06B 3/663

(52) U.S. Cl. CPC E06B 3/663; E06B 3/66304; E06B 2003/7059

(57) ABSTRACT

Spacers/spacer frame assemblies for use in insulating glass units that include offset seams and methods of using and manufacturing the same are described herein.

### RELATED APPLICATION

The present application claims the benefit under 35 U.S.C. §119(e) of U.S. Provisional Patent Application 62/127,603 filed on Mar. 3, 2015, which is hereby incorporated by reference in its entirety.

Insulating glass units with offset seam spacers/spacer frame assemblies and methods of using and manufacturing the same are described herein.

### BACKGROUND

Insulating glass units typically include two panes of glass or a similar material separated by a spacer/spacer frame assembly. The spacer/spacer frame assembly extends around or near the perimeter of the panes to provide an interior volume located between the panes to, e.g., limit thermal transfer through the insulating glass unit. Examples of some insulating glass units and methods of manufacturing them are described in, e.g., U.S. Pat. No. 5,177,916 (Misera et al.), U.S. Pat. No. 5,313,761 (Leopold), U.S. Pat. No. 5,361,476 (Leopold), U.S. Pat. No. 7,021,110 (Rosskamp), U.S. Pat. No. 7,448,246 (Briese et al.), and U.S. Pat. No. 8,720,026 (McGlinchy).

### SUMMARY

Insulating glass units with offset seam spacers/spacer frame assemblies and methods of using and manufacturing the same are described herein.

The spacer/spacer frame assemblies and the insulating glass units described herein include a spacer seam that is offset from a corner of the spacer/spacer frame assembly and an insulating glass unit incorporating the same. A spacer seam offset from a corner of the insulating glass unit may, in one or more embodiments, provide an insulating glass unit with improved resistance to penetration by moisture, leakage, etc.

The position of the spacer seams of spacers/spacer frame assemblies as described herein may be controlled through mechanical interference in a variety of ways. For example, an insert portion/connecting structure of a spacer segment may be inserted into an opposing spacer segment such that the insert portion butts into or bottoms out in a corner of the spacer/spacer frame assembly. In one or more alternative embodiments, one or more other features may provide mechanical interference (also referred to herein as a stop) to assist in proper positioning on the insert portion/connecting structure such as, e.g., swedging or narrowing of the insert portion/connecting structure, widening of a spacer segment at a base of the insert portion, and the ends of the stiffening flanges/return legs on the first portion of the first spacer segment and the fifth spacer segment may meet to restrict further insertion of the insert portion. In one or more embodiments, the ends of sealant on the spacers/spacer frame assemblies may also abut each other to provide mechanical interference that assists in positioning.

In one or more embodiments, the spacer/spacer frame assemblies described herein may include a locking mechanism configured to couple the first spacer segment to the fifth spacer segment (other than and/or in addition to sealant and/or a friction fit as described herein). The locking mechanism may position the first spacer segment in relation to the fifth spacer segment such that the segments are properly aligned with each other and/or help maintain that positioning.

In one aspect, one or more embodiments of an insulating glass unit as described herein may include: a first pane comprising an interior surface and an exterior surface; a second pane comprising an interior surface facing the interior surface of the first pane and an exterior surface facing away from the first pane; and a spacer/spacer frame assembly located between the first and second panes, wherein the spacer/spacer frame assembly extends from a first end to a second end, wherein an interior volume of the insulating glass unit is defined between the first pane, the second pane, and the spacer/spacer frame assembly, wherein the spacer/spacer frame assembly defines a first corner, a second corner, a third corner, and a fourth corner positioned around a perimeter of the interior volume, wherein the spacer/spacer frame assembly comprises a first spacer segment extending between the first end and the first corner, a second spacer segment extending between the first corner and the second corner, a third spacer segment extending between the second corner and the third corner, a fourth spacer segment extending between the third corner and the fourth corner, and a fifth spacer segment extending between the fourth corner and the second end, wherein the first spacer segment and the fifth spacer segment overlap between the first corner and the fourth corner and define an exterior seam/union point outside of the interior volume at the second end of the spacer/spacer frame assembly, and wherein the exterior seam/union point is located between the first corner and the fourth corner.

In one or more embodiments, the insulating glass unit defines a spacer width measured between the interior surfaces of the first and second panes at the exterior seam/union point, and wherein the exterior seam/union point is located a seam offset distance away from the fourth corner, wherein the seam offset distance is greater than or equal to the spacer width.

In one or more embodiments, the exterior seam/union point is located a seam offset distance away from the fourth corner, and wherein the seam offset distance is greater than or equal to 5% of a length of the first spacer segment extending between the first end of the spacer/spacer frame assembly and the first corner.

In one or more embodiments, the exterior seam/union point is located a seam offset distance away from the fourth corner, and wherein the seam offset distance is less than or equal to 35% of a length of the first spacer segment extending between the first end of the spacer/spacer frame assembly and the first corner.

In one or more embodiments, each spacer segment of the spacer/spacer frame assembly comprises a first side portion/wall, a second side portion/wall, and a bridge portion extending between the first and second side portions/walls, wherein the first and second side portions/walls are transverse to the bridge portion such that an exterior surface of the first side portion/wall faces the interior surface of the first pane and an exterior surface of the second side portion/wall faces the interior surface of the second pane, and wherein the spacer/spacer frame assembly defines an inner width between an interior surface of the first side portion/wall and an interior surface of the second side portion/wall and an outer width between the exterior surface of the first side portion/wall and the exterior surface of the second side portion/wall. In one or more embodiments, the first spacer segment comprises a first portion and an insert portion/connecting structure, wherein the outer width of the insert portion/connecting structure is less than or equal to the inner width of the fifth spacer segment, wherein the insert portion/connecting structure is configured to be inserted into the fifth spacer segment such that the exterior surfaces of the first and second side portions/walls of the insert portion/connecting structure face the interior surfaces of the first and second side portions/walls of the fifth spacer segment.

In one or more embodiments, the first spacer segment and the fifth spacer segment overlap between the first corner and the fourth corner and define an interior seam within the interior volume at the first end of the spacer/spacer frame assembly.

In one or more embodiments, the insulating glass units described herein further include a locking mechanism configured to couple the first spacer segment to the fifth spacer segment. In one or more embodiments, the locking mechanism comprises a locking tab on the first spacer segment and an interlocking structure on the fifth spacer segment, wherein the locking tab is configured to engage the interlocking structure to couple the first spacer segment to the fifth spacer segment.

In one or more embodiments, a length of the fifth spacer segment as measured between the fourth corner and the second end of the spacer/spacer frame assembly is less than or equal to a length of the first spacer segment as measured between the first end of the spacer/spacer frame assembly and the first corner. In one or more embodiments, at least a portion of the first spacer segment is between the fifth spacer segment and the interior volume.

In one or more embodiments, the first spacer segment comprises an aperture located between the exterior seam/union point and the first corner, wherein the aperture is configured to provide fluid passage into or out of the interior volume.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

Where used herein, the terms “top” and “bottom” are used for reference relative to each other when the insulating glass units described herein are properly installed in a building opening.

The above summary is not intended to describe each embodiment or every implementation of the insulating glass units with offset seam spacers/spacer frame assemblies and methods described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

FIG. 1 depicts one illustrative embodiment of a spacer/spacer frame assembly including an offset seam as described herein.

FIG. 2 is a perspective view of one illustrative embodiment of an insulating glass unit that may include a spacer/spacer frame assembly as described herein;

FIG. 3 is an enlarged fragmentary cross sectional view seen approximately from the plane indicated by the line 3-3 in FIG. 2;

FIG. 4 is a side view of two portions of the spacer/spacer frame assembly of FIG. 1, the view including segments of the spacer/spacer frame assembly as described herein.

FIG. 5 is a top view of the spacer/spacer frame assembly of FIG. 1.

FIG. 6 is an enlarged view of a portion of one of the spacer/spacer frame assembly segments of FIG. 4.

FIG. 7A is an enlarged view of portions of the spacer/spacer frame assembly segments of FIG. 4 inserted within one another according to one illustrative embodiment.

FIG. 7B is an enlarged view of portions of the spacer/spacer frame assembly segments of FIG. 4 inserted within one another according to another illustrative embodiment.

FIG. 8 is a cross-sectional view of the spacer/spacer frame assembly of FIG. 1 taken along line 8-8 in FIG. 1, with a pair of glass panels located on opposite sides of the spacer/spacer frame assembly.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

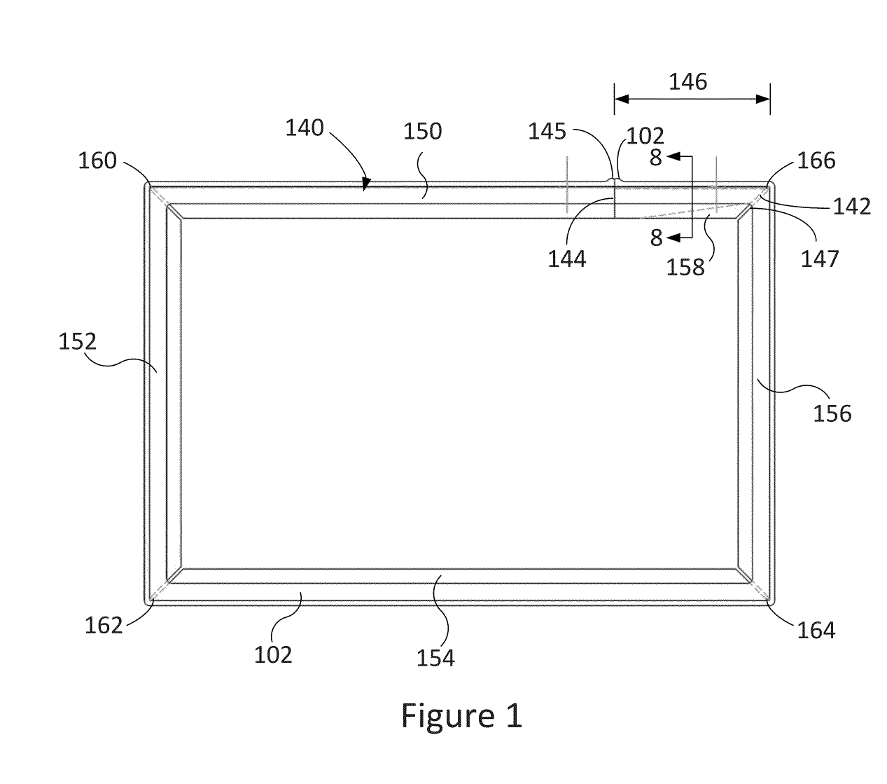

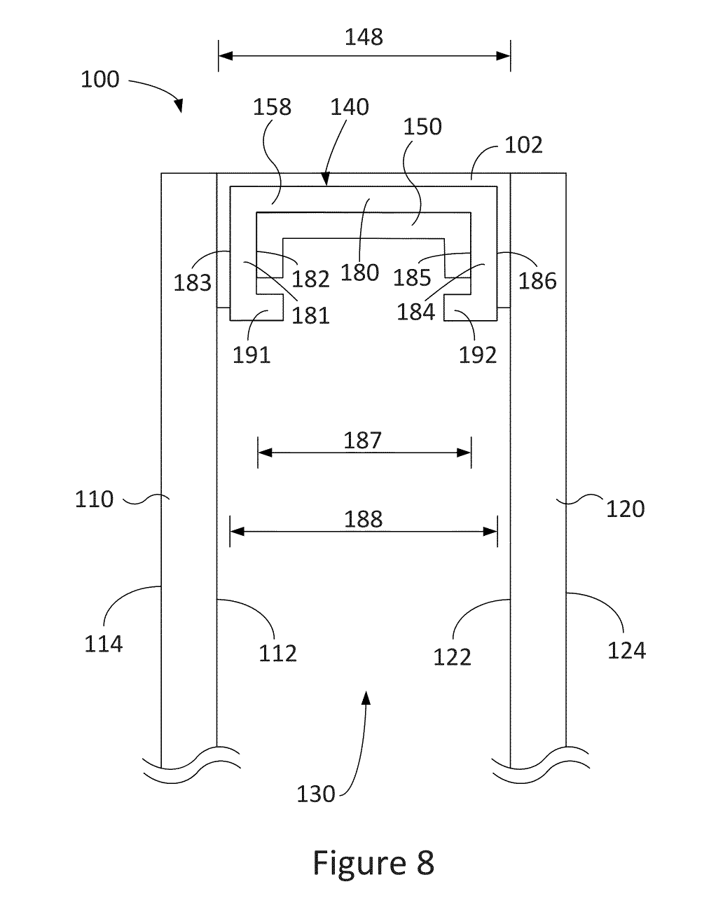

One illustrative embodiment of a spacer/spacer frame assembly for an insulating glass unit is depicted in FIGS. 1 and 8, where FIG. 8 is a cross-sectional view of the spacer/spacer frame assembly 140 taken along line 8-8 in FIG. 1 with panes 110 and 120 added in FIG. 8 to form an insulated glass unit 100. The insulating glass unit 100 includes a first pane 110 and a second pane 120. The first and second panes 110, 120 may be constructed of glass or any other material suitable for an insulating glass unit 100. The first pane 110 includes an interior surface 112 and an exterior surface 114 opposite the interior surface 112. The second pane 120 includes an interior surface 122 and an exterior surface 124 opposite the interior surface 122. The interior surface 122 of the second pane 120 faces the interior surface 112 of the first pane 110 and the exterior surface 124 of the second pane 120 faces away from the first pane 110. The insulating glass unit 100 further includes a spacer/spacer frame assembly 140 located between the first and second panes 110, 120. An interior volume 130 of the insulating glass unit 100 is defined between the first pane 110, the second pane 120, and the spacer/spacer frame assembly 140.

The insulating glass unit 100 includes sealant 102 (e.g., butyl rubber, etc.) located between the spacer/spacer frame assembly 140 and each of the first and second panes 110, 120. The sealant 102 may, in one or more embodiments, seal the junctions between the spacer/spacer frame assembly 140 and the first and second panes 110, 120 to seal the interior volume 130 of the insulating glass unit 100. The sealant 102 may also be used to attach the first and second panes 110, 120 to the spacer/spacer frame assembly 140. The sealant 102 that is proximate an exterior seam/union point 145 may, in one or more embodiments, bulge outwardly due to excess sealant 102 being pressed together when a first spacer/spacer frame assembly segment 150 of the spacer/spacer frame assembly 140 is inserted into a fifth spacer/spacer frame assembly segment 158 of the spacer/spacer frame assembly 140.

Now with reference back to FIG. 1, the spacer/spacer frame assembly 140 extends from a first end 142 to a second end 144. In other words, the spacer/spacer frame assembly 140 is, in one or more embodiments, provided as one continuous piece or ribbon extending between the first and second ends 142, 144. In one or more embodiments, the spacer/spacer frame assembly 140 may be constructed of metals (e.g., stainless steel material such as, e.g., 304 stainless steel having a thickness of 0.006-0.010 inches), polymers, elastomeric materials, and one or more combinations thereof. The ribbon of material may be passed through forming rolls to produce the side portions/walls, bridge portion, and stiffening flanges/return legs. Before forming the ribbon into an elongated linear rigid channel member, the ribbon may be processed to form corners and other structures found in the spacers/spacer frame assemblies described herein.

In the depicted illustrative embodiment in which the insulating glass unit 100 is in the form of a rectangle, the spacer/spacer frame assembly 140 defines a first corner 160, a second corner 162, a third corner 164, and a fourth corner 166. Each of the four corners 160, 162, 164, 166 are positioned around a perimeter of the interior volume 130 which is depicted at the center of the insulating glass unit 100 (see, e.g., FIG. 8) within each of the four corners 160, 162, 164, 166. Each of the four corners 160, 162, 164, 166 may, in one or more embodiments, be formed by removing a portion of the material making up the spacer/spacer frame assembly 140 such that, after forming, the sides of the spacer/spacer frame assembly 140 form mitered joints at each corner.

In the depicted illustrative embodiment, the spacer/spacer frame assembly 140 may be described as including a first spacer segment 150 extending between the first end 142 of the spacer/spacer frame assembly 140 and the first corner 160. A second spacer segment 152 of the illustrative embodiment of spacer/spacer frame assembly 140 extends between the first corner 160 and the second corner 162. A third spacer segment 154 extends between the second corner 162 and the third corner 164, and a fourth spacer segment 156 extends between the third corner 164 and the fourth corner 166. Finally, a fifth spacer segment 158 extends between the fourth corner 166 and the second end 144 of the spacer/spacer frame assembly 140.

Although the depicted insulating glass unit 100 is the form of a rectangle, one or more alternative embodiments of glass units that may be formed using a spacer/spacer frame assembly as described herein may take any selected polygonal shape and, as a result, have a suitable number of segments and corners needed to take that shape. For example, in one or more embodiments, an insulating glass unit may include three segments and three corners to form a triangular insulating glass unit. In one or more alternative embodiments, an insulating glass unit as described herein may form a pentagon, hexagon, etc., with the number of segments and corners needed to form the selected shape.

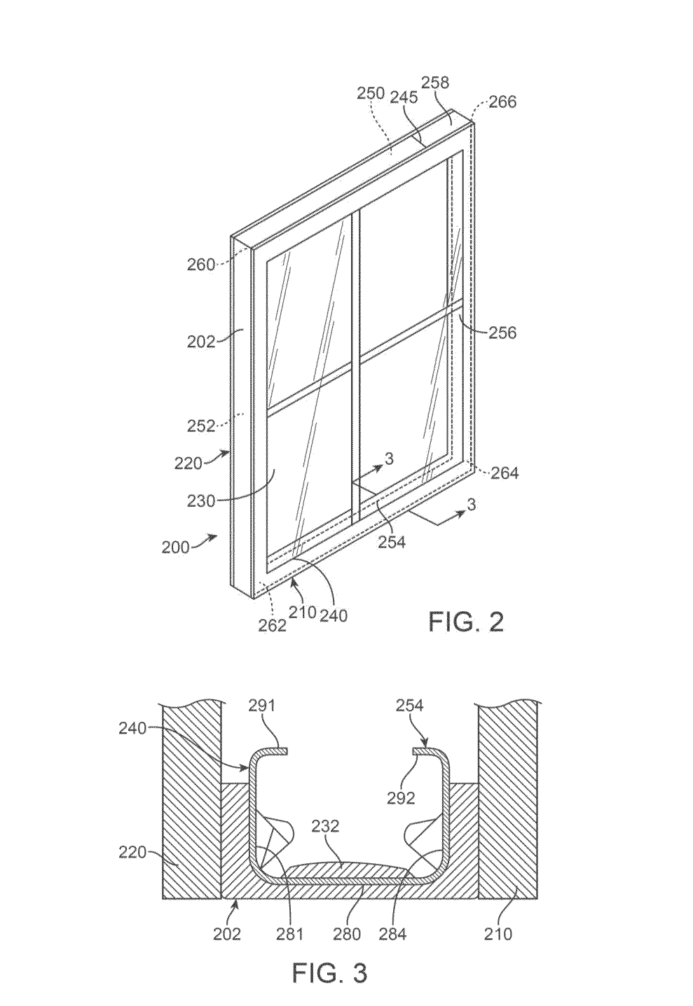

Another illustrative embodiment of an insulating glass unit 200 including a spacer/spacer frame assembly 240 sandwiched between panes 210, 220 is depicted in FIGS. 2 and 3. The insulating glass unit 200 includes spacer/spacer frame assembly 240, sealant material 202 for hermetically joining the spacer/spacer frame assembly 240 to the panes 210, 220 to form a closed space/interior volume 230 within the unit 200 and desiccant 232 in the space/interior volume 230. The desiccant 232 serves to remove water vapor from air, or other gas, entrapped in the space/interior volume 230 during construction of the insulating glass unit 200.

The spacer/spacer frame assembly 240 extends about the unit periphery to provide a structurally strong, stable spacer for maintaining the panes 210, 220 aligned and spaced. In one embodiment, the spacer/spacer frame assembly 240 includes a first spacer segment 250, second spacer segment 252, third spacer segment 254, fourth spacer segment 256, and fifth spacer segment 258. The spacer segments are connected to form a planar, polygonal frame shape with the spacer segment junctures forming a first corner 160, second corner 162, third corner 164 and fourth corner 166. Although not depicted in FIG. 2 or 3, the first spacer segment 250 of the spacer/spacer frame assembly also includes an insert portion configured for insertion into the fifth spacer segment 258 as described herein.

Each spacer segment is elongated and has a channel shaped cross section defining a bridge portion (peripheral wall) 280 and first and second lateral side walls 281 and 284 (see FIG. 3). The bridge portion 280 extends continuously about an insulating glass unit 200 incorporating a spacer/spacer frame assembly 240 as described herein except where the insert portion of the first spacer segment 250 joins with the fifth spacer segment 258 to form an exterior seam/union point 245 that is located between the first corner 260 and the fourth corner 266 as described herein. The lateral side walls 281 and 284 are integral with respective opposite sides of the bridge portion 280. The lateral walls 281 and 284 extend inwardly from the bridge portion 280.

The spacer/spacer frame assembly 240 includes stiffening flanges/return legs 291, 292 formed along the inwardly projecting lateral side walls 281 and 284. The lateral side walls 281 and 284 rigidify the side walls and spacer segments so they resist flexure and bending in a direction transverse to their longitudinal extents.

In one or more embodiments, the spacer/spacer frame assembly 240 may be constructed from a thin ribbon of material (e.g., metal) which is passed through forming rolls to produce the bridge portion 280 and side walls 281 and 284. The formed ribbon may be described as an elongated linear rigid channel member.

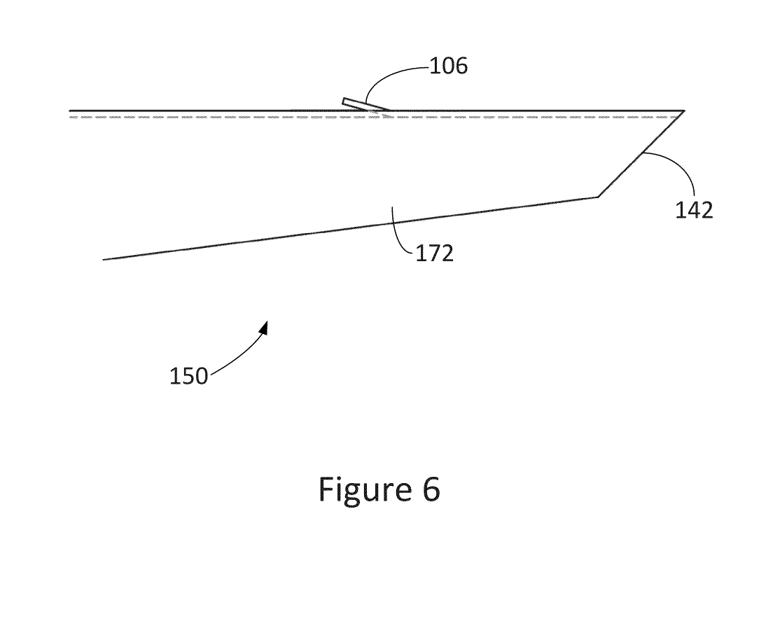

The frame corners 260, 262, 264, and 266 may be formed from structures that facilitate manual frame bending to the final, polygonal frame configuration of the spacer/spacer frame assembly 240 in the insulating glass unit 200 while assuring an effective vapor seal at the corners. In one or more embodiments, the spacer/spacer frame assembly 240 may be formed in a single straight length with the sealant 202 in place on the straight length. The corner structures used to form corners 260, 262, 264, and 266 may be in the form of notches and weakened zones formed in the side walls 281 and 284 at frame corner locations. The notches may extend into the side walls 281 and 284 from the respective side wall edges (see, e.g., notches 50 and weakened zones 52 in FIG. 6 of U.S. Pat. No. 5,313,761). The side walls 281 and 284 extend continuously along the spacer/spacer frame assembly 240 from one end to the other.

The side walls 281 and 284 are weakened at the corner locations because the notches reduce the amount of side wall material and eliminate the stiffening flanges/return legs 291, 292. As discussed herein, the flanges/return legs 291, 292 are also not present on the insert portion of the first spacer segment (see, e.g., FIG. 8 and the corresponding discussion). In other words, the flanges/return legs 291, 292 terminate at the base of the insert portion on the first spacer segment 250 (where the insert portion is that portion of the first spacer segment 250 inserted into the fifth spacer segment 258 as a part of the connecting structure of the spacer/spacer frame assemblies described herein).

Because the flanges/return legs 291, 292 are present on the fifth spacer segment 258 as well as the first spacer segment 250 (up to the base of the insert portion), the ends of the flanges/return legs 291, 292 on the first spacer segment 250 meet the ends of the flanges/return legs 291, 292 on the fifth spacer segment 258 and may, in one or more embodiments, function as a stop for proper positioning of the insert portion of the first spacer segment 250 and the fifth spacer segment 258.

With reference to the illustrative embodiment of the spacer/spacer frame assembly 140 depicted in FIGS. 1, 4, and 5, the first spacer segment 150 and the fifth spacer segment 158 overlap between the first corner 160 and the fourth corner 166 in one or more embodiments of the spacers/spacer frame assemblies described herein. In other words, the first spacer segment 150 and the fifth spacer segment 158 are aligned with each other along the side of the spacer/spacer frame assembly 140 or insulating glass unit 100 located between the first and fourth corners 160, 166. The overlapping of the first spacer segment 150 and the fifth spacer segment 158 defines, in the depicted illustrative embodiment, an exterior seam/union point 145 (that would be, e.g., outside of the interior volume 130 of an insulating glass unit) at the second end 144 of the spacer/spacer frame assembly 140. The exterior seam/union point 145 is located between the first corner 160 and the fourth corner 166.

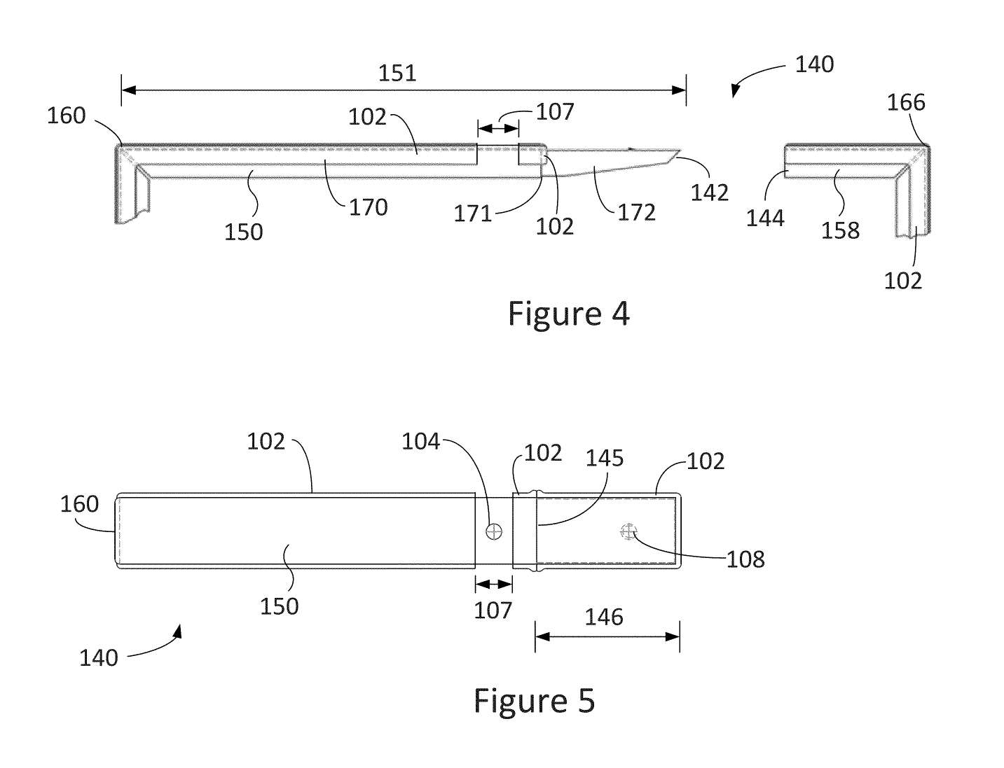

The exterior seam/union point 145 may, in one or more embodiments, be located a seam offset distance 146 away from the fourth corner 166. In one or more embodiments, the seam offset distance 146 may be described in relation to the length 151 (see FIG. 4) of the first spacer segment 150 between the first end 142 of the spacer/spacer frame assembly 140 and the first corner 160. In one or more embodiments, at the lower end of the range, the seam offset distance 146 may be, e.g., greater than or equal to 5%, greater than or equal to 10%, greater than or equal to 15%, greater than or equal to 20%, greater than or equal to 30%, etc. of the length 151 of the first spacer segment 150 between the first end 142 of the spacer/spacer frame assembly 140 and the first corner 160. In one or more embodiments, at the upper end of the range, the seam offset distance 146 may be, e.g., less than or equal to 60%, less than or equal to 50%, less than or equal to 45%, less than or equal to 40%, less than or equal to 35%, less than or equal to 25%, etc. of the length 151 of the first spacer segment 150 between the first end 142 of the spacer/spacer frame assembly 140 and the first corner 160. The upper and lower ends of the range of the seam offset distance 146 may also be between any combination of the lower and upper ranges described above. In the depicted illustrative embodiment, the seam offset distance 146 is about 25% of the length 151 of the first spacer segment 150 between the first end 142 of the spacer/spacer frame assembly 140 and the first corner 160.

In one or more embodiments, the first spacer segment 150 and the fifth spacer segment 158 may overlap between the first corner 160 and the fourth corner 166 and define an interior seam 147 within the interior volume 130 at the first end 142 of the spacer/spacer frame assembly 140. In other words, the first spacer segment 150 and the fifth spacer segment 158 overlap with a portion of the first spacer segment 150 facing the interior volume 130 inside of the fifth spacer segment 158 proximate the fourth corner 166.

With reference again to FIG. 8, the fifth spacer segment 158 of a spacer/spacer frame assembly 140 as described herein may include, in one or more embodiments, a first side portion/wall 181, a second side portion/wall 184, and a bridge portion 180 extending between the first and second side portions/walls 181, 184. The first and second side portions/walls 181, 184 may be transverse to the bridge portion 180 such that an exterior surface 183 of the first side portion/wall 181 faces the interior surface 112 of the first pane 110 and an exterior surface 186 of the second side portion/wall 184 faces the interior surface 122 of the second pane 120. The first and second side portions/walls 181, 184 may also include corresponding first and second return leg portions (e.g., flanges) 191, 192 extending from an end of each of the first and second side portions/walls 181, 184 that is opposite the bridge portion 180 and towards the interior volume 130.

In some embodiments, for example as shown in FIG. 8, sealant 102 is located on an exterior surface of the bridge portion 180 of the fifth spacer segment 158 opposite the interior volume 130. In one or more embodiments, the sealant 102 on the spacer/spacer frame assembly 140 is flush with edges of the first and second panes 110, 120. In other embodiments, the sealant 102 may extend past the edges of the first and second panes 110, 120. In still other embodiments, the sealant 102 may be recessed between the edges of the first and second panes 110, 120.

The sealant 102 is also located on the exterior surfaces of the first and second side portions/walls of the spacer/spacer frame assembly 140 and may be used to both attach the panes 110, 120 to the spacer/spacer frame assembly 140 and seal the junctions between panes 110, 120 and the spacer/spacer frame assembly 140. For example, as shown in FIG. 8, the sealant 102 is located on the exterior surfaces of the first and second side portions/walls of the fifth spacer segment 158. In one or more embodiments, the first and second panes 110, 120 and the spacer/spacer frame assembly 140 are positioned to form an insulating glass unit after the sealant 102 has been applied to the spacer/spacer frame assembly 140. As a result, the sealant 102 is located between the first and second side portions/walls and the corresponding first and second panes 110, 120.

The spacer/spacer frame assembly 140 (and sealant 102 if present) may define a spacer width 148 (see, e.g., FIG. 8) measured between the interior surfaces 112, 122 of the first and second panes 110, 120 at the exterior seam/union point 145. In one or more embodiments, this spacer width 148 may be less than the seam offset distance 146, or described alternatively, the seam offset distance 146 may be greater than or equal to the spacer width 148. The spacer/spacer frame assembly 140 may, in one or more embodiments, define an inner width 187 between an interior surface 182 of the first side portion/wall 181 and an interior surface 185 of the second side portion/wall 184. The spacer/spacer frame assembly 140 may also, in one or more embodiments, define an outer width 188 between the exterior surface 183 of the first side portion/wall 181 and the exterior surface 186 of the second side portion/wall 184. In some embodiments, the inner width 187 or the outer width 188 may be less than the seam offset distance 146 (as depicted in FIG. 1). Alternatively, in some embodiments, the seam offset distance 146 may be described as being greater than or equal to the inner or outer width 187, 188 of the spacer/spacer frame assembly 140.

FIG. 4 is a side view of one illustrative embodiment of the first spacer segment 150 and the fifth spacer segment 158. The first spacer segment 150 and the fifth spacer segment 158 are depicted in FIG. 4 as spaced apart from each other before the first spacer segment 150 and the fifth spacer segment 158 are positioned to provide an exterior seam/union point on the spacer/spacer frame assembly and an insulating glass unit incorporating the same as described herein.

In one or more embodiments, the first spacer segment 150 includes a first portion 170 and an insert portion/connecting structure 172. The insert portion/connecting structure 172 of the first spacer segment 150 may be configured to be inserted into the fifth spacer segment 158. The insert portion/connecting structure 172 of the first spacer segment 150 may, in one or more embodiments, not include a first and second return leg portion 191, 192 (see, e.g., the fifth spacer segment 158 in FIG. 8). The lengths of the first portion 170 and the insert portion/connecting structure 172 may vary depending on the insulating glass unit 100. In the depicted illustrative embodiment, the length of the insert portion/connecting structure 172 is less than the length of the first portion 170 such that the insert portion/connecting structure 172 is shorter than the first portion 170 as measured from the first corner 160 to the first end 142 of the spacer/spacer frame assembly 140. In one or more embodiments, the length of the insert portion/connecting structure 172 may be the same as the length of the fifth spacer segment 158. In other embodiments, the length of the insert portion/connecting structure 172 may be less than the length of the fifth spacer segment 158 from the second end 144 of the spacer/spacer frame assembly 140 to the fourth corner 166.

The first spacer segment 150 may be configured to be inserted into the fifth spacer segment 158 in a variety of ways. For example, in one embodiment, the outer width of the first spacer segment 150 may be less than or equal to the inner width of the fifth spacer segment 158. In one or more embodiments, the first spacer segment 150 transitions from one outer width defined by the first portion 170 to a second outer width defined by the insert portion/connecting structure 172 at an intersection of the first portion 170 and the insert portion/connecting structure 172. This reduction in the outer width of the first spacer segment 150 may, in one or more embodiments, be performed by a swedging process. Therefore, more specifically, the outer width of the insert portion/connecting structure 172 of the first spacer segment 150 may be less than or equal to the inner width of the fifth spacer segment 158. As a result, the first spacer segment 150 may be easily inserted into the fifth spacer segment 158 such that the exterior surfaces 183, 186 of the first and second side portions/walls 181, 184 of the first spacer segment 150 (e.g., the insert portion/connecting structure 172) face the first and second side portions/walls of the fifth spacer segment 158, respectively.

In one or more alternative embodiments, the outer width of the insert portion/connecting structure 172 may be slightly larger than the inner width of the fifth spacer segment 158 such that the insert portion/connecting structure 172 is retained within the fifth spacer segment 158 by a friction fit between the insert portion/connecting structure 172 and the fifth spacer segment 158.

In the depicted illustrative embodiment, the first spacer segment 150 (specifically the insert portion/connecting structure 172 of the first spacer segment 150) is inserted into the fifth spacer segment such that the fifth spacer segment 158 is positioned over the first spacer segment 150. In other words, at locations where the first spacer segment 150 and the fifth spacer segment 158 overlap, the first spacer segment 150 is closer to the interior volume 130 than the fifth spacer segment 158. Put another way, at least a portion of the first spacer segment 150 is between at least a portion of the fifth spacer segment 158 and the interior volume 130. Specifically, the insert portion/connecting structure 172 of the first spacer segment 150 is between the fifth spacer segment 158 and the interior volume 130.

In some embodiments, for example as shown in FIG. 4, the insert portion/connecting structure 172 of the first spacer segment 150 may be generally free of sealant 102 (e.g., a minimal amount or none at all) because the insert portion/connecting structure 172 is configured to be placed within the fifth spacer segment 158. In one or more embodiments, such as the illustrative embodiment depicted in FIG. 4, the sealant 102 extends onto only a limited part of the insert portion/connecting structure (e.g., 0.06 inches measured from the intersection between the first portion 170 and the insert portion/connecting structure 172 of the first spacer segment 150). As a result, the sealant 102 may form a bulge (see, e.g., FIGS. 1 and 5) at the exterior seam/union point 145 when the insert portion/connecting structure 172 is placed within the fifth spacer segment 158. The amount of sealant 102 located on the insert portion/connecting structure 172 may, in one or more embodiments, not unduly inhibit insertion of the insert portion/connecting structure 172 into the fifth spacer segment 158. In one or more embodiments in which sealant 102 is provided on insert portion/connecting structure 172 of the first spacer segment 150, the sealant may assist in retaining the insert portion/connecting structure 172 in the fifth segment 158 after insertion therein.

A top view of the illustrative embodiment of the spacer/spacer frame assembly 140 used in the insulating glass unit 100 is illustrated in FIG. 5. In one or more embodiments, the first spacer segment 150 may comprise an aperture 104 located between the exterior seam/union point 145 and the first corner 160. The aperture 104 may be configured to provide fluid passage into or out of the interior volume 130. For example, after assembly of the insulating glass unit 100, the interior volume 130 may be filled with argon (or any other suitable gas or gasses) through, e.g., an aperture 104. After filling, any aperture used to fill the insulating glass unit 100 may be closed such that the interior volume 130 retains the gas or gasses delivered therein. The aperture or apertures may be closed by one or more of the following techniques, e.g., covering the aperture or apertures with adhesive tape, inserting a plug, screw, rivet, etc.

Although the aperture 104 is located in the first spacer segment 150 in the depicted illustrative embodiment, in one or more alternative embodiments, one or more apertures used to fill the insulating glass unit 100 with any selected gas or gasses may be located at any suitable location on the spacer/spacer frame assembly 140. In other words, one or more apertures may be located on any spacer segment of a spacer/spacer frame assembly used in an insulating glass unit as described herein. In one or more embodiments in which an aperture is provided in the fifth spacer segment 158, a corresponding aperture may need to be provided in the insert portion/connecting structure 172 of the first spacer segment 150, with the apertures in the fifth spacer segment 158 and the insert portion/connecting structure 172 being aligned with each other when the insert portion/connecting structure 172 is properly located within the fifth spacer segment 158. That alignment is needed to allow for filling of the interior volume 130 of the insulating glass unit 100 as discussed herein.

Sealant 102 may be applied to the spacer/spacer frame assembly 140 to assist with sealing the interior volume 130 and/or attach the panes 110, 120 to the spacer/spacer frame assembly 140. In one or more embodiments, sealant 102 may be applied continuously about the perimeter of the spacer/spacer frame assembly 140. In one or more embodiments, a portion of the spacer/spacer frame assembly 140 may be free of sealant 102 where, for example, the aperture 104 is located, such that the aperture 104 remains open to the passage of gas or gasses into and/or out of the interior volume 130 of the insulating glass unit 100. In the illustrative embodiment depicted in, e.g., FIGS. 4 and 5, the aperture 104 is located within zone 107 on the first spacer segment 150 that is free of the sealant 102.

For example, in those embodiments in which the sealant 102 is applied in a continuous process to the material used to form spacer/spacer frame assembly 140, the sealant delivery mechanism/process may be controlled such that sealant 102 is not applied to one or more selected zones of the material forming the spacer/spacer frame assembly 140. In one or more embodiments of the spacers/spacer frame assemblies used in glass units as described herein, the material used to form spacer/spacer frame assembly 140 may include two zones in which sealant 102 is not applied. Those zones in which sealant 102 is not applied include, in the depicted illustrative embodiment, zone 107, in which aperture 104 is located, as well as a zone containing the bulk of the insert portion/connecting structure 172.

Although the zone containing the insert portion/connecting structure 172 may, in one or more embodiments, be free of any sealant 102, the insert portion/connecting structure 172 is, as described herein, located within the fourth spacer segment 158 which does include sealant 102. As a result, the lack of sealant on the insert portion/connecting structure 172 does not affect sealing or attachment of the spacer/spacer frame assembly 140 to the panes 110, 120 of the insulating glass unit 100.

The zone 107 in which aperture 104 is located does, however, remain exposed after assembly of the spacer/spacer frame assembly 140 to form an insulating glass unit 100 as described herein. As a result, additional sealant may, in one or more embodiments, be applied to the zone 107 containing aperture 104 after the aperture 104 has been closed as described herein (e.g., by covering aperture 104 with tape, inserting a plug, screw, rivet, etc. into the aperture 104). In one or more embodiments, the additional sealant applied to a zone such as a zone 107 may itself be used to close the aperture 104 in place of a separate step of closing the aperture 104 (e.g., by covering aperture 104 with tape, inserting a plug, screw, rivet, etc. into the aperture 104).

An enlarged side view of the insert portion/connecting structure 172 of the first spacer segment 150 is illustrated in FIG. 6. As discussed herein, the insert portion/connecting structure 172 of the first spacer segment 150 may, in one or more embodiments, be configured to be inserted into the fifth spacer segment 158. A bottom edge of the insert portion/connecting structure 172 may, as seen in the illustrative embodiment depicted in FIGS. 4 and 6, be angled to facilitate insertion of the insert portion/connecting structure 172 into the fifth spacer segment 158. Further, the first end 142 of the spacer/spacer frame assembly 140 that defines one edge of the insert portion/connecting structure may be further angled to align with the mitered edges of the spacer/spacer frame assembly 140 at the fourth corner 166 (e.g., at miter joint as shown in FIG. 1).

In one or more embodiments, the spacer/spacer frame assemblies used in insulating glass units may include a locking mechanism configured to couple the first spacer segment 150 to the fifth spacer segment 158 (other than and/or in addition to sealant and/or a friction fit as described herein). The locking mechanism may position the first spacer segment 150 in relation to the fifth spacer segment 158 such that the segments are properly aligned with each other and/or help maintain that positioning. The locking mechanism may include anything suitable for retaining the first spacer segment 150 and the fifth spacer segment 158 in a selected position relative to one another. One illustrative embodiment of a locking mechanism, as depicted in FIGS. 5 and 6, may include a locking tab 106 on the first spacer segment 150 and an interlocking structure or receptor 108 on the fifth spacer segment 158. Specifically, the locking tab 106 may be positioned on the insert portion/connecting structure 172 of the first spacer segment 150. The locking tab 106 is configured to engage the interlocking structure 108 to couple the first spacer segment 150 to the fifth spacer segment 158.

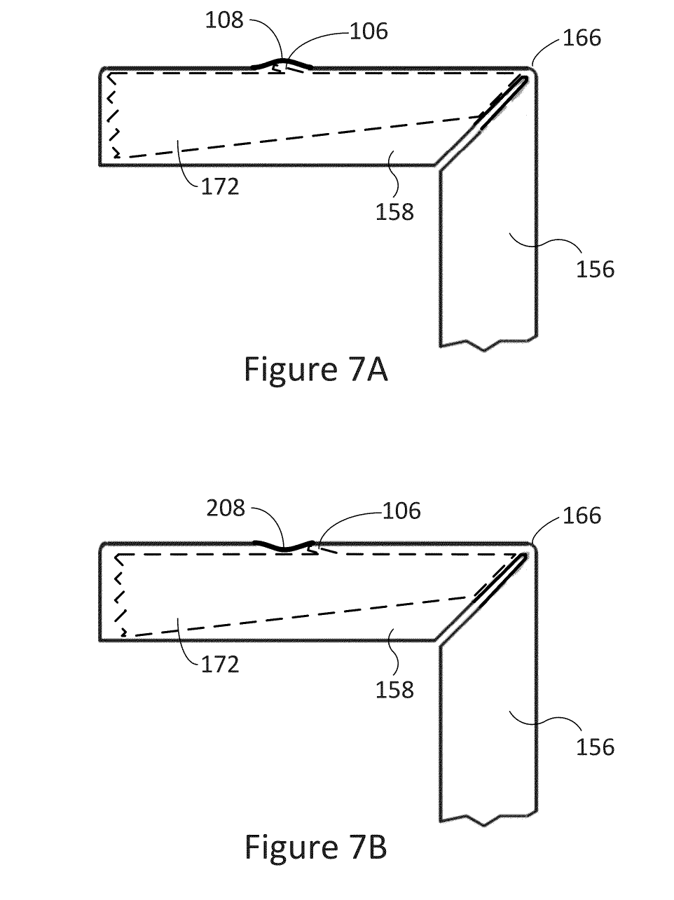

An enlarged side view of the insert portion/connecting structure 172 engaged within the fifth spacer segment 158 is illustrated in FIGS. 7A and 7B, which include two illustrative embodiments of interlocking structures 108, 208 that may be used in connection with the locking tabs 106. In one or more embodiments, the interlocking structures 108, 208 may be defined by a stamped portion of the fifth spacer segment 158. In other words, the interlocking structures 108, 208 may not break the seal of or create an aperture in the fifth spacer segment 158. In some embodiments, the interlocking structures 108, 208 may be, e.g., a dimple, an indentation, a recess, a pit, a bump, etc. that defines a shape that may be, e.g., convex, concave, etc.

In one illustrative embodiment, FIG. 7A illustrates an interlocking structure 108 that protrudes from the fifth spacer segment 158 and engages the locking tab 106 of the insert portion/connecting structure 172. In such an embodiment, the locking tab 106 may move upwardly into the recess formed within the interlocking structure 108 when the locking tab 106 and the structure 108 are aligned. Movement of the insert portion/connecting structure 172 and its locking tab 106 would be limited because movement of the locking tab 106 out of the recess in the interlocking structure 108 would require deflection of the locking tab 106.

In another illustrative embodiment, FIG. 7B illustrates an interlocking structure 208 that is recessed into the fifth spacer segment 158 and engages the locking tab 106 of the insert portion/connecting structure 172. In such an embodiment, movement of the insert portion/connecting structure 172 to the left (out of the fifth spacer segment 158) may be resisted by the locking tab 106 because moving the locking tab 106 to the left past the interlocking structure 208 would require that the locking tab 106 deflect downwardly.

Proper positioning of the insert portion/connecting structure 172 of the first spacer segment 150 relative to the fifth spacer segment 158 such that the first corner 160 is located a selected distance from the fourth corner 166 in an assembled spacer/spacer frame assembly 140 is required to form a spacer/spacer frame assembly having a selected shape. In the case of a rectangular spacer/spacer frame assembly such as that depicted in the illustrative embodiment of FIG. 1, the selected distance between the first corner 160 and the fourth corner 166 is essentially equal to the distance between the second corner 162 and the third corner 164. In one or more alternative embodiments such as, e.g., a trapezoidal spacer/spacer frame assembly used in a trapezoidal insulating glass unit, the distance between the first corner 160 and the fourth corner 166 may be any selected distance required to form the proper trapezoidal shape, etc.

Proper positioning of the insert portion/connecting structure 172 of the first spacer segment 150 relative to the fifth spacer segment 158 may be achieved by a variety of techniques and/or structures. In one or more embodiments, the insert portion/connecting structure 172 may be sized such that it butts into (e.g., bottoms out) the fourth corner 166 formed between the fourth spacer segment 156 and the fifth spacer segment 158. Further advancement of the insert portion/connecting structure 172 is basically prevented as the first end 142 reaches the fourth corner 166 (see, e.g., FIGS. 7A and 7B for enlarged views of such an arrangement). This is one form of a stop that may be provided to limit advancement of the insert portion/connecting structure 172 into the fifth spacer segment 158.

In one or more alternative embodiments, one or more other features may provide a stop to assist in proper positioning on the insert portion/connecting structure 172 in the fifth spacer segment 158. Such one or more other features may be needed to assist in proper positioning of the insert portion/connecting structure 172 where, for example, the length of the insert portion/connecting structure 172 is less than the length of the fifth spacer segment 158 from the second end 144 of the spacer/spacer frame assembly 140 to the fourth corner 166 (in which case the end 142 on the insert portion/connecting structure 172 would not reach the fourth corner 166 formed at the junction of the fifth spacer segment 158 and the fourth spacer segment 156 and could not be used to position the exterior seam/union point 145 as discussed herein).

One example of alternative positioning features/stops may include, as discussed herein, swedging or narrowing of the insert portion/connecting structure 172 such that it fits within the fifth spacer segment 158. The remainder of the first spacer segment 150 however, has a width that is equal to the width of the fifth spacer segment 158. As a result, the first spacer segment 150 may be described as widening at the base 171 of the insert portion/connecting structure 172 and that widened portion of the first spacer segment 150 at the base 171 of the insert portion/connecting structure 172 may, in one or more embodiments, limit/stop further advancement of the insert portion/connecting structure 172 into the fifth spacer segment 158 by simple mechanical interference between the widened portion and the second end 144 of the fifth spacer segment 158. That widened portion may alternatively be referred to as a shoulder or bump, with the shoulder or bump forming a stop against which the second end 144 of the spacer/spacer frame assembly rests. Limiting further advancement of the insert portion/connecting structure using the shoulder/bump/widening at the base 171 of the insert portion/connecting structure 172 may assist in providing proper positioning of the insert portion/connecting structure 172 and the fifth spacer segment 158.

Another feature that may assist in providing proper positioning of the insert portion/connecting structure 172 relative to the fifth spacer segment 158 is the sealant 102 that may be located on both the first spacer segment 150 and the fifth spacer segment 158. As seen in, e.g., FIGS. 1, 4 and 5, the sealant 102 terminates, in one or more embodiments, near the base 171 of the insert portion/connecting structure 172 and the sealant 102 also terminates at the second end 144 of the spacer/spacer frame assembly 140 on the end of the fifth spacer segment 158. The ends of the sealant 102 may, as described herein, abut each other to restrict insertion of insert portion/connecting structure 172 into the fifth spacer segment 158 to assist with proper positioning of the insert portion/connecting structure 172. That interference between the ends of the two sealant layers may also, in one or more embodiments, provide a visual and/or physical indication that the insert portion/connecting structure 172 and the fifth spacer segment 158 are properly positioned with respect to each other.

With reference to FIGS. 2 and 3, still another feature that may assist in providing proper positioning of the insert portion/connecting structure relative to the fifth spacer segment in spacer/spacer frame assemblies as described herein may be found in the flanges/return legs 291, 292. Because the flanges/return legs 291, 292 are present on the fifth spacer segment 258 as well as the first spacer segment 250 (up to the base of the insert portion), the ends of the flanges/return legs 291, 292 on the first spacer segment 250 meet the ends of the flanges/return legs 291, 292 on the fifth spacer segment 258 and may, in one or more embodiments, provide mechanical interference to function as a stop for proper positioning of the insert portion of the first spacer segment 250 and the fifth spacer segment 258.

Another feature that may be found in the spacer/spacer frame assemblies described herein is orthogonal shape of the exterior seam/union points. With reference to, e.g., FIGS. 1, 4, and 5, the second end 144 on the fifth spacer segment 158 is formed orthogonal to the length of the fifth spacer segment 158. As a result, the exterior seam/union point 145 formed by the second end 144 is shorter than a conventional seam found at a corner of spacer frame assembly (which is mitered to form an angle that is not orthogonal to the length of the segments forming conventional spacer frame assemblies).

Although the illustrative embodiments of insulating glass units and spacers/spacer frame assemblies described herein include two glass panes, it should be understood that spacers with offset seams as described herein could be use in insulating glass units with any number of panes and corresponding interior volumes (e.g., insulating glass units with three or more panes).

The complete disclosure of the patents, patent documents, and publications identified herein are incorporated by reference in their entirety as if each were individually incorporated. To the extent there is a conflict or discrepancy between this document and the disclosure in any such incorporated document, this document will control.

Also incorporated by reference is US Patent Application Publication US 2015/0361713 (Briese et al.) for its disclosure relating to concepts derived from the inventor of this application.

Illustrative embodiments of the insulating glass units including offset seam spacers and methods are discussed herein and some possible variations have been described. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof. It should also be understood that this invention also may be suitably practiced in the absence of any element not specifically disclosed as necessary herein.

What is claimed is:

1. An insulating glass unit comprising:
a first pane comprising an interior surface and an exterior surface;
a second pane comprising an interior surface facing the interior surface of the first pane and an exterior surface facing away from the first pane; and
a spacer located between the first and second panes, wherein the spacer extends from a first end to a second end,
wherein an interior volume of the insulating glass unit is defined between the first pane, the second pane, and the spacer,
wherein the spacer defines a first corner, a second corner, a third corner, and a fourth corner positioned around a perimeter of the interior volume,
wherein the spacer comprises a first spacer segment extending between the first end and the first corner, a second spacer segment extending between the first corner and the second corner, a third spacer segment extending between the second corner and the third corner, a fourth spacer segment extending between the third corner and the fourth corner, and a fifth spacer segment extending between the fourth corner and the second end, wherein the first spacer segment and the fifth spacer segment overlap between the first corner and the fourth corner and define an exterior seam outside of the interior volume at the second end of the spacer, and wherein the exterior seam is located between the first corner and the fourth corner.

2. The insulating glass unit of claim 1, wherein the insulating glass unit defines a spacer width measured between the interior surfaces of the first and second panes at the exterior seam, and wherein the exterior seam is located a seam offset distance away from the fourth corner, wherein the seam offset distance is greater than or equal to the spacer width.

3. The insulating glass unit of claim 1, wherein the exterior seam is located a seam offset distance away from the fourth corner, and wherein the seam offset distance is greater than or equal to 5% of a length of the first spacer segment extending between the first end of the spacer and the first corner.

4. The insulating glass unit of claim 1, wherein the exterior seam is located a seam offset distance away from the fourth corner, and wherein the seam offset distance is less than or equal to 35% of a length of the first spacer segment extending between the first end of the spacer and the first corner.

5. The insulating glass unit of claim 1, wherein each spacer segment of the spacer comprises a first side wall, a second side wall, and a bridge portion extending between the first and second side walls, wherein the first and second side walls are transverse to the bridge portion such that an exterior surface of the first side wall faces the interior surface of the first pane and an exterior surface of the second side wall faces the interior surface of the second pane, and wherein the spacer defines an inner width between an interior surface of the first side wall and an interior surface of the second side wall and an outer width between the exterior surface of the first side wall and the exterior surface of the second side wall.

6. The insulating glass unit of claim 5, wherein the first spacer segment comprises a first portion and an insert portion, wherein the outer width of the insert portion is less than or equal to the inner width of the fifth spacer segment, wherein the insert portion is configured to be inserted into the fifth spacer segment such that the exterior surfaces of the first and second side walls of the insert portion face the interior surfaces of the first and second side walls of the fifth spacer segment.

7. The insulating glass unit of claim 1, wherein the first spacer segment and the fifth spacer segment overlap between the first corner and the fourth corner and define an interior seam within the interior volume at the first end of the spacer.

8. The insulating glass unit of claim 1, further comprising a locking mechanism configured to couple the first spacer segment to the fifth spacer segment.

9. The insulating glass unit of claim 8, wherein the locking mechanism comprises a locking tab on the first spacer segment and an interlocking structure on the fifth spacer segment, wherein the locking tab is configured to engage the interlocking structure to couple the first spacer segment to the fifth spacer segment.

10. The insulating glass unit of claim 1, wherein a length of the fifth spacer segment as measured between the fourth corner and the second end of the spacer is less than or equal to a length of the first spacer segment as measured between the first end of the spacer and the first corner.

11. The insulating glass unit of claim 10, wherein at least a portion of the first spacer segment is between the fifth spacer segment and the interior volume.

12. The insulating glass unit of claim 1, wherein the first spacer segment comprises an aperture located between the exterior seam and the first corner, wherein the aperture is configured to provide fluid passage into or out of the interior volume.

13. The insulating glass unit of claim 1, wherein the exterior seam is located a seam offset distance away from the fourth corner, and wherein the seam offset distance is limited by mechanical interference.

14. The insulating glass unit of claim 13, wherein the mechanical interference comprises abutment of the first end of the spacer in the fourth corner of the spacer.

15. The insulating glass unit of claim 13, wherein the first spacer segment comprises a first portion located between the first corner and the insert portion of the first spacer segment, and wherein the insert portion is narrowed such that the insert portion fits within the fifth spacer segment, and wherein the mechanical interference comprises mechanical interference of the fifth spacer segment with the first spacer segment.

16. The insulating glass unit of claim 15, wherein the mechanical interference of the fifth spacer segment with the first spacer segment comprises mechanical interference of the second end of the spacer with the first spacer segment.

17. The insulating glass unit of claim 15, wherein the mechanical interference of the fifth spacer segment with the first spacer segment comprises mechanical interference of the second end of the spacer with the first spacer segment at a base of the insert portion, where the base of the insert portion is located at a transition between the first portion and insert portion of the first spacer segment.

18. The insulating glass unit of claim 13, wherein the spacer comprises sealant located thereon, the sealant comprising a first end on the first spacer segment and a second end on the fifth spacer segment, wherein the mechanical interference comprises abutting the first end of sealant on the first spacer segment against the second end of sealant on the fifth spacer segment.

19. The insulating glass unit of claim 13, wherein the first portion of the first spacer segment and the fifth spacer segment both comprise a first side wall, a second side wall, and a bridge portion extending between the first and second side walls, wherein the first and second side walls are transverse to the bridge portion such that an exterior surface of the first side wall faces the interior surface of the first pane and an exterior surface of the second side wall faces the interior surface of the second pane;
wherein the first side wall of the first portion of the first spacer segment comprises a flange that extends towards the second side wall of the first portion and wherein the second side wall of the first portion of the first spacer segment comprises a flange that extends towards the first side wall of the first portion of the first spacer segment;
wherein the flanges extending from the first and second side walls of the first portion of the first spacer segment terminate at first spacer segment flange ends located at the transition between the first portion and the insert portion of the first spacer segment;
wherein the first side wall of the fifth spacer segment comprises a flange that extends towards the second side wall of the fifth spacer segment and wherein the second side wall of the fifth spacer segment comprises a flange that extends towards the first side wall of the fifth spacer segment;
wherein the flanges extending from the first and second side walls of the fifth spacer segment terminate at fifth spacer segment flange ends located at the second end of the spacer;
and wherein the first spacer segment flange ends meet the fifth spacer segment flange ends to provide the mechanical interference between the first spacer segment and the fifth spacer segment.

20. A spacer frame for an insulating glass unit, the spacer frame comprising:
a channel extending from a first end to a second end, wherein the channel defines a first corner, a second corner, a third corner, and a fourth corner of the spacer frame between the first end and the second end;
wherein the channel further comprises:
a first spacer segment extending between the first end and the first corner, wherein only a portion of the first spacer segment comprises an insert portion extending from the first end towards the first corner;
a second spacer segment extending between the first corner and the second corner;
a third spacer segment extending between the second corner and the third corner;
a fourth spacer segment extending between the third corner and the fourth corner; and
a fifth spacer segment extending between the fourth corner and the second end;
wherein each of the first, second, third, fourth, and fifth spacer segments of the channel comprises a first side wall, a second side wall, and a bridge extending between the first and second side walls;
wherein the fifth spacer segment overlaps the insert portion of the first spacer segment between the first corner and the fourth corner such that the second end of the channel forms an exterior seam on the first spacer segment;
and wherein the exterior seam is located between the first corner and the fourth corner.

21. The spacer frame of claim 20, wherein the fifth spacer segment defines a spacer frame width measured between the first and second side walls of the channel, and wherein the exterior seam is located a seam offset distance away from the fourth corner, wherein the seam offset distance is greater than or equal to the spacer frame width.

22. The spacer frame of claim 20, wherein the first spacer segment comprises a first portion located between the first corner and the insert portion of the first spacer segment, and wherein the first portion of the first spacer segment comprises a width that is equal to a width of the fifth spacer segment, wherein the width of the first portion of the first spacer segment is measured between the first and second side walls of the channel in the first portion of the first spacer segment, and wherein the width of the fifth spacer segment is measured between the first and second side walls of the channel in the fifth spacer segment.

23. The spacer frame of claim 20, wherein the exterior seam is located a seam offset distance away from the fourth corner, and wherein the seam offset distance is limited by mechanical interference.

24. The spacer frame of claim 23, wherein the mechanical interference comprises abutment of the first end of the channel in the fourth corner of the channel.

25. The spacer frame of claim 23, wherein the first spacer segment comprises a first portion located between the first corner and the insert portion of the first spacer segment, and wherein the insert portion is narrowed such that the insert portion fits within the fifth spacer segment, and wherein the mechanical interference comprises mechanical interference of the fifth spacer segment with the first spacer segment.

26. The spacer frame of claim 25, wherein the mechanical interference of the fifth spacer segment with the first spacer segment comprises mechanical interference of the second end of the channel with the first spacer segment.

27. The spacer frame of claim 25, wherein the mechanical interference of the fifth spacer segment with the first spacer segment comprises mechanical interference of the second end of the channel with the first spacer segment at a base of the insert portion, where the base of the insert portion is located at a transition between the first portion and insert portion of the first spacer segment.

28. The spacer frame of claim 23, wherein the spacer comprises sealant located thereon, the sealant comprising a first end on the first spacer segment and a second end on the fifth spacer segment, wherein the mechanical interference comprises abutting the first end of sealant on the first spacer segment against the second end of sealant on the fifth spacer segment.

29. The spacer frame of claim 23, wherein the first spacer segment comprises a first portion located between the first corner and the insert portion of the first spacer segment,
wherein the first portion of the first spacer segment and the fifth spacer segment both comprise a first side wall, a second side wall, and a bridge portion extending between the first and second side walls, wherein the first and second side walls are transverse to the bridge portion;
wherein the first side wall of the first portion of the first spacer segment comprises a flange that extends towards the second side wall of the first portion and wherein the second side wall of the first portion of the first spacer segment comprises a flange that extends towards the first side wall of the first portion of the first spacer segment;
wherein the flanges extending from the first and second side walls of the first portion of the first spacer segment terminate at first spacer segment flange ends located at the transition between the first portion and the insert portion of the first spacer segment;
wherein the first side wall of the fifth spacer segment comprises a flange that extends towards the second side wall of the fifth spacer segment and wherein the second side wall of the fifth spacer segment comprises a flange that extends towards the first side wall of the fifth spacer segment;
wherein the flanges extending from the first and second side walls of the fifth spacer segment terminate at fifth spacer segment flange ends located at the second end of the spacer;
and wherein the first spacer segment flange ends meet the fifth spacer segment flange ends to provide the mechanical interference between the first spacer segment and the fifth spacer segment.

30. The spacer frame of claim 20, wherein the exterior seam is located a seam offset distance away from the fourth corner, and wherein the seam offset distance is greater than or equal to 5% of a length of the first spacer segment between the first end of the channel and the first corner.

31. The spacer frame of claim 20, wherein the exterior seam is located a seam offset distance away from the fourth corner, and wherein the seam offset distance is less than or equal to 35% of a length of the first spacer segment between the first end of the channel and the first corner.

32. The spacer frame of claim 20, wherein a length of the fifth spacer segment as measured between the fourth corner and the second end of the channel is less than a length of the first spacer segment as measured between the first end of the channel and the first corner.

33. The spacer frame of claim 20, wherein the first spacer segment comprises an aperture through the bridge of the first spacer segment between the exterior seam and the first corner, wherein the aperture is configured to provide fluid passage into or out of the interior volume.

34. The spacer frame of claim 20, wherein the first spacer segment comprises a first aperture through the bridge of the first spacer segment in the insert portion of the first spacer segment, and wherein the fifth spacer segment comprises a second aperture through the bridge of the fifth spacer segment between the second end of the channel and the fourth corner, and further wherein the first aperture and the second aperture are aligned with each other when the insert portion is properly located within the fifth spacer segment.

35. A spacer frame assembly comprising:
a substantially linear channel having first and second ends, the substantially linear channel that when assembled. includes at least three sides and corresponding corners between each of said sides;
a connecting structure located at one of said first and second ends and an opposite frame end located at the other of said. one of first and second ends, the opposite frame end having an inner channel for receiving a nose portion of said connecting structure;
a stop extending from said connecting structure for locating the opposite frame end when in the assembled position; and
a lateral connection spaced from said corresponding corners and along one of said at least three sides, the lateral connection forming a union point between said opposite frame end and said connecting structure.

36. The spacer frame assembly of claim 35 wherein said stop comprises first and second stiffening flanges that abuttingly engage said opposite frame end to form the repeatably located union point.

37. The spacer frame assembly of claim 35 wherein said connecting structure and opposite frame end comprise a peripheral wall spacing transversely first and second lateral wails to form a u-shaped channel.

38. The spacer frame assembly of claim 35 wherein said connecting structure and opposite frame end comprise a peripheral wall spacing transversely first and second lateral walls to form a u-shaped channel, projecting from said first and second lateral walls is a respective stiffening flange, said stiffening flange in said connecting structure acting as said stop to engage said stiffening flange in said opposite frame end.

39. The spacer frame assembly of claim 38 wherein stiffening flanges are projected transversely from said lateral walls of said connecting structure and opposite frame end and are further substantially parallel with respective peripheral wall.

40. The spacer frame assembly of claim 35 wherein said corners connecting said at least three corners arc identically constructed when said spacer frame assembly is in its fully assembled position.

41. The spacer frame assembly of claim 35 wherein said connecting structure and opposite frame end each further comprise an aperture for receiving a fastener, said apertures being substantially concentrically aligned when said opposite frame end engages said stop located on said connecting structure.

42. The spacer frame assembly of claim 35 wherein each of said at least three sides further comprise a peripheral wall spacing transversely first and second lateral walls to form a unshaped channel, projecting from said first and second lateral walls is a spaced and respective stiffening flange, said stiffening flange in said connecting structure acting as said stop to engage said stiffening flange in said opposite frame end.

43. A method of making a spacer frame assembly for bending into a multi-sided window or door spacer frame comprising:
a) providing a supply of narrow metal strip coiled on a support;
b) unwinding the metal strip from the support to provide an elongated metal strip and moving the elongated metal strip along a. path of travel to a stamping station;
c) stamping the strip at spaced apart corner locations by removing portions of said strip at said corner locations wherein inter-fitting leading and trailing ends of the spacer frame assembly are defined by a lead portion of said strip extending in front a first corner location and a trailing portion of said strip extending behind a second corner location;
d) additionally stamping at least one. of the lead and trailing portions of said strip to form an abutment stop comprising a wide portion of the strip and a nose which extends into said wide portion of said strip for defining an amount of overlap of the leading and trailing ends an assembled spacer frame;
e) roll forming the strip to form a channel shaped structure having side walls that include the abutment stop and a base wall extending between the side walls; and
f) severing the frame assembly from the elongated metal strip.

44. The method of claim 43 additionally comprising applying a sealant to outer surfaces of the side and base walls of said spacer frame assembly after to severing the frame assembly from the elongated metal strip.

45. The method of claim 43 wherein the severing step forms an abutment engaging end of the spacer frame assembly.

46. A spacer frame assembly for bending into a multi-sided window or door spacer frame comprising: an elongated metal strip bent to form a channel shaped frame element having a base wall that extends between two generally parallel side walls wherein the side walls include spaced apart corner locations defined by notches that extend from an edge of the metal strip into the side walls and wherein telescoping leading and trailing ends of the frame element are defined by a lead portion of said frame element in front and spaced from a first corner location, and a trailing portion of said frame element behind and spaced from a second corner location wherein at least one of the lead and trailing portions of said frame element include an abutment stop defined by a notch which extends into a side wall of said frame element, the abutment stop for limiting movement of the leading and trailing ends as said leading and trailing ends are telescoped one within the other and thereby define a lateral connection spaced from said corners and an. amount of overlap of the leading and trailing ends of the assembled spacer frame.

47. The spacer frame assembly of claim 46 wherein the channel shaped frame element includes stiffening flanges that extend into a center region of the channel shaped frame element and wherein the notch that defines the abutment stop is formed by a gap in at least one of the stiffening flanges of one of said loading or trailing ends of the frame element.

48. The spacer frame assembly of claim 46 wherein said abutment stop is integrally formed in and as part of said elongated metal strip bent to form said channel shaped frame element.

49. The spacer frame assembly of claim 46 wherein said trailing portion and leading portion each further comprise an aperture for receiving a fastener, said apertures being substantially concentrically aligned when said one of said leading portion and trailing portion engage said abutment stop on said other of said leading portion and trailing portion.

50. The spacer frame assembly of claim 47 wherein said stiffening flanges extend transversely from each of said parallel walls and are spaced to form a unshaped gap around the internal perimeter of said channel shaped frame element.

51. The spacer frame assembly of claim 46 wherein one of said leading portion and trailing portions includes a tapered swaged portion for receiving the other of said leading portion and trailing portion.

52. The spacer frame assembly of claim 35 wherein said connecting structure further comprises a tapered nose such that when said nose is inserted into said opposite frame end a telescopic lateral connection is formed of decreasing clearance to an interference fit.

53. The spacer frame assembly of claim 52 wherein said nose of said connecting structure farther comprises a tapered width such that when said nose is inserted into said opposite frame end a telescopic lateral connection is formed of decreasing clearance to an interference fit and said nose further comprising an inclined profile such that said inclined profile remains below said stiffening flanges of said opposite frame end for ease of assembly.

54. The spacer frame assembly of claim 35 wherein at least one of said sides is differently constructed than the other remaining sides.

55. The spacer frame assembly of claim 54 wherein said differently constructed side is formed by a lateral connection from a corner such that said connecting structure is telescopically received by said opposite frame end, the connecting structure further comprising said stop such that it engages a portion on said opposite frame end to form a union point.

56. The spacer frame of claim 35 wherein said stop comprises a physical stop projecting outward from one of lateral walls forming the linear channel and peripheral wall.

57. A spacer frame assembly comprising:
a substantially linear channel having first and second ends, the substantially linear channel when assembled including at least three sides and corresponding corners between each of said sides;
a connecting structure located at one of said first and second ends and an opposite frame end located at the other of said first and second ends, the opposite frame end having an inner channel for receiving a nose portion of said connecting structure; and
a stop extending from said connecting structure for locating the opposite frame end when in the assembled position.

58. The spacer frame assembly of claim 57 wherein said connecting structure and opposite frame end comprise a peripheral wall spacing transversely first and second lateral walls to form a u-shaped channel, projecting from said first and second lateral walls is a respective stiffening flange, said stiffening flange in said connecting structure acting as said stop to engage said stiffening flange in said opposite frame end.

59. The spacer frame assembly of claim 57 wherein the linear channel comprises side walls and wherein the stop comprises a bump in one side wall spaced from a corner such that as said connecting structure is telescopically received by said opposite frame end said stop engages a portion of said frame end to limit movement of the connecting structure with respect to said opposite frame end.
